(19) United States
(12) Patent Application Publication
(10) Pub. No.: US 2014/0023755 A1
(43) Pub. Date: Jan. 23, 2014

(54) CLAMSHELL GRILL AND METHOD WITH PRODUCT COOK PROCEDURES

(71) Applicant: Garland Commercial Industries, LLC, Freeland, PA (US)

(72) Inventors: Jan Claesson, Land O' Lakes, FL (US); Michael Sykes, Orangeville (CA); Michael Bergeron, Mississauga (CA); Douglas S. Jones, New Port Richie, FL (US)

(21) Appl. No.: 13/935,288

(22) Filed: Jul. 3, 2013

Related U.S. Application Data
(60) Provisional application No. 61/667,883, filed on Jul. 3, 2012.

(51) Int. Cl. A47J 37/06; A47J 37/04

(52) U.S. Cl. CPC A47J 37/0611; A47J 37/049
USPC 426/231; 99/372

(57) ABSTRACT

A clamshell grill having a user interface and a processor that executes one or more programs to select an initial cooking recipe for a food product, by determining an actual product thickness of the food product, determining if the actual product thickness of the food product is greater than or less than the cooking recipe's product thickness, and if the actual product thickness of the food product is greater than or less than the cooking recipe's product thickness, then executing a modified cooking recipe to accommodate a change in the actual product thickness during a cooking cycle, wherein the modified cooking recipe adjusts at least one parameter of the initial cooking recipe.

### RELATED APPLICATION

This application claims priority to U.S. Provisional Application No. 61/667,883, filed on Jul. 3, 2012, the entire contents of which are hereby incorporated herein.

### BACKGROUND

1. Field

This disclosure relates to a clamshell grill and method utilizing improved cook procedures to ensure the proper and safe cooking of a food product regardless of nominal variations of product thickness.

2. Discussion of the Background Art

Clamshell cooking utilizes a movable upper platen cook surface which is lowered to a pre-programmed cooking position relative to a lower cook surface based on a menu item selection and its' associated recipe, i.e. time, temperature and gap. A safety issue is always a concern with clamshell grill, i.e. ensure that the food product is properly and thoroughly cooked. However, thickness of food products vary both at the onset of the cooking cycle and throughout the duration of the cooking cycle. Preset or initial cooking recipes are established based upon the type of food product that will be cooked. The initial cooking recipe typically includes parameters, such as, cooking time, cooking temperature and the gap between the upper and lower platens. However, food product thickness is not always constant, hence the preset cooking parameters do not always result in a properly cooked and/or safe food product.

Accordingly, there is a need for adjusting such cooking parameters at the onset or throughout the duration of the cooking operations, thereby avoiding overcooked, undercooked or unsafely cooked food products. In addition, there is a need, particularly in large chain food service institutions, to maintain a constant quality and taste of food product regardless of the differing thickness of the food product.

### SUMMARY

Current grill operations can be enhanced through an innovative program which utilizes a single cook mode. The manual menu encompasses all the necessary initial cooking recipes which are selected based on restaurant product needs. Once the initial cooking recipe is selected and the product is placed on the lower platen or grill, the cook cycle is initiated. The current method sends the platen to a specific cook height based on the selection. This program monitors the upper platen's position with respect to the lower platen or grill top and validates that the product is encountered at the expected height within designated limits.

A cooking program or recipe can be modified by differences in product thicknesses which are not the nominal thickness by adjusting both cook time and gap slightly for better product quality and food safety.

A clamshell grill comprising: at least one upper platen and a lower platen; a positioning mechanism; a controller comprising a processor, a memory, and at least one program: at least one initial cooking recipe stored in the memory, each the initial cooking recipe comprising at least one cooking parameter selected from the group consisting of: a cooking time, cooking temperature and a cooking gap between the upper and lower platens; and a user interface that allows a user to select the cooking recipe for a food product disposed on the lower platen; wherein the processor executes the programs to perform operations comprising: operating the positioning mechanism to move the upper platen toward the lower platen until the food product is detected by position sensor, verifying that the thickness of the product falls within thickness parameters of the recipe; and determining if a thickness of the food product is greater than or less than an expected product height; and if the thickness of the food product is greater than or less than the expected product height in the initial cooking recipe, then executing a modified cooking recipe to accommodate a change in the thickness of the food product during a cooking cycle, wherein the modified cooking recipe adjusts at least one the parameter of the initial cooking recipe.

Each of the parameters of the initial recipe include an upper and lower limit. If the cooking gap is within the upper or lower limits, then a cooking operation for cooking the food product is executed by adjusting the cooking temperature and/or the cooking time and/or gap.

The operations further comprise: cancelling the initial cooking recipe selection if the thickness of the food product is outside the upper or lower limit of the cooking gap as identified within the initial cooking recipe on the lower platen.

The program continues to determine if the thickness of the food product is greater than or less than the expected product thickness in a cooking recipe, then executing a modification to the cooking recipe that matches a change in the thickness of the food product until cessation of the cooking operation.

A clamshell grill comprising: an upper platen and a lower platen; a plurality of cook zones disposed on the lower platen and the upper platen; each of the cook zones comprising a temperature sensor and a heater, each of the upper platens comprising of a distance sensor; and a controller comprising a processor and a gap compensation program, wherein the processor executes the gap compensation program to obtain gap values from each of the distance sensors, to calculate a delta of a difference between a set point and the gap value for each of the cook lane, and to adjust a cook cycle gap based on the plurality of deltas. The adjustment comprises an expansion or retraction of the cook cycle gap for a product currently being cooked.

A method adjusting cooking parameters of a cooking recipe for operation of a clamshell grill comprising: at least one upper platen and a lower platen; a positioning mechanism; a controller comprising a processor, a memory, and at least one program; at least one initial cooking recipe stored in the memory, each the initial cooking recipe comprising at least one cooking parameter selected from the group consisting of: a cooking time, cooking temperature and a cooking gap between the upper and lower platens; and a user interface that allows a user to select the initial cooking recipe for a food product disposed on the lower platen; the method comprising: operating the positioning mechanism to move the upper platen toward the lower platen until the food product height is detected by position sensor, verifying that the thickness of the product falls within thickness parameters of the recipe; determining if a thickness of the food product is greater than or less than the expected product height; and if the thickness of the food product is greater than or less than the expected product height in the cooking recipe, executing a modified cooking recipe to accommodate a change in the thickness of the food product during a cooking cycle, wherein the modified cooking recipe adjusts at least one the parameter of the initial cooking recipe.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a perspective view of one embodiment of a clamshell grill of the present disclosure;

FIG. 2 is a side view of the clamshell grill of FIG. 1;

FIG. 3 is a rear view of the clamshell grill of FIG. 1;

FIG. 4 is a top view of the upper platen assembly of the clamshell grill of FIG. 1;

FIG. 5 is a cross-sectional view along line 5 of FIG. 4;

FIG. 6 is a view of detail B of FIG. 5;

FIG. 7 is a block diagram of a preferred embodiment of the controller of the clamshell grill of FIG. 1; and

FIG. 8 is a flow diagram of the production selection correction program of the controller of FIG. 7.

### DETAILED DESCRIPTION OF THE PREFERRED EMBODIMENT

It is contemplated that the cook procedures of the present disclosure can be implemented in various styles of clamshell grills. However, by way of example and completeness of description, the present disclosure will be described herein in a clamshell grill embodiment as shown in U.S. Pat. No. 8,109,202, which is incorporated herein by reference in its entirety.

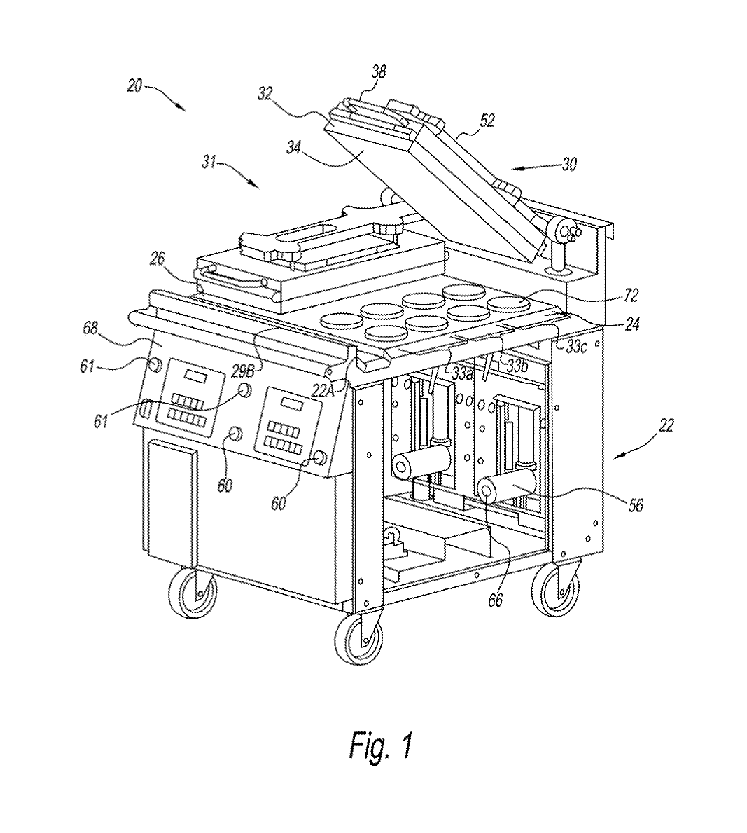

Referring to FIGS. 1-3, a clamshell grill 20 of the present disclosure comprises a support structure 22 to which a lower (first) cooking platen 24 is horizontally mounted. Lower platen 24 has a smooth level cooking surface 26 on its upper side. Lower platen 24 is heated to cooking temperature by gas or electric means via heating elements 28 or equivalent gas burners or induction elements. A front heating element 28(a), a middle heating element 28(b) and a rear heating element 28(c) are disposed in a front cooking zone 33a, a middle cooking zone 33b and a rear cooking zone 33c, respectively, of lower cooking platen 24. A front temperature sensor 90(a), a middle temperature sensor 90(b) and a rear temperature sensor 90(c) are disposed in a front cooking zone 33a, a middle cooking zone 33b and a rear cooking zone 33c, respectively, of lower cooking platen 24. Each grill 20 includes at least one cooking lane (e.g., 29A,B) which traverses from the front to the back of grill 20, and each cooking lane (29A,B) include a front cooking zone 33a, a middle cooking zone 33b and a rear cooking zone 33c.

A platen assembly 30 and a platen assembly 31 are movably mounted to the rear of support structure 22 by a positioning mechanism 40 and a positioning mechanism 41, respectively. As platen assembly 30 and platen assembly 31 are substantially identical, only platen assembly 30 will be described in detail. Platen assembly 30 comprises an upper (second) cooking platen 32 that has a surface 34. Preferably, surface 34 is heated to cooking temperature by heating elements (not shown) mounted within a casing 36. Upper platen 32 is either smaller than or equivalently sized to lower cooking platen 24. A handle 38 may optionally be mounted on the front side of platen assembly 30 for manual manipulation thereof. Clamshell grill 20 may have one or more upper platen assemblies. Although two upper platen assemblies are shown, other embodiments may have one or more than two upper platen assemblies. In a preferred embodiment, two or more separate upper platen assemblies are mounted over a single lower platen, allowing for greater flexibility for the cook/operator. Although lower platen 24 is shown as a single platen, it can be two or more platens in alternate embodiments.

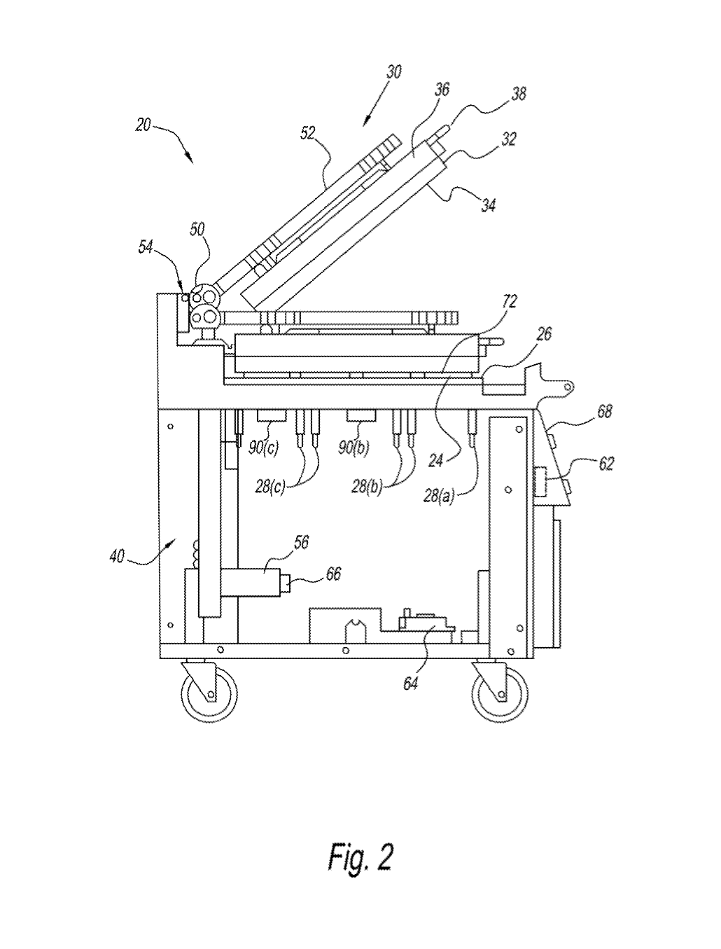

Clamshell grill 20 further includes a controller 62 (shown in FIG. 2) that is interconnected with heaters 28, a motor controller 64, a user interface 68, one or two activation buttons 60 and temperature sensors 90. Controller 62 controls the cook cycle of clamshell grill 20 and in so doing controls motor controller 64 and positioning mechanism 40 that imparts motion to platen assembly 30. User interface 68 includes a display and various user controls. Activation buttons 60 are disposed on the front of clamshell grill 20 for user control of platen assembly 30. Activation buttons 61 are disposed on the front of clamshell grill 20 for user control of platen assembly 31.

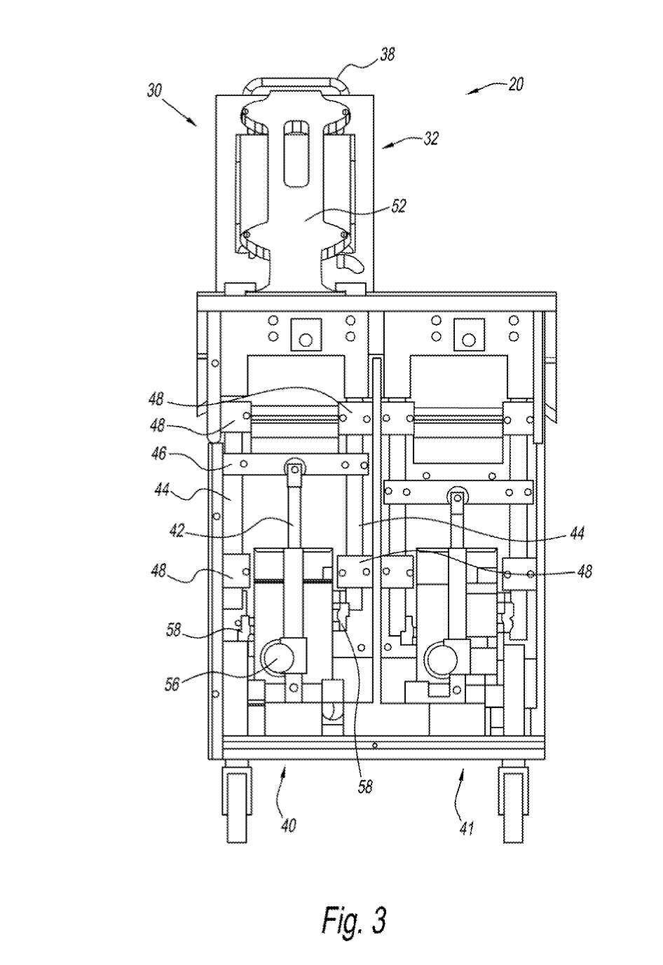

As positioning mechanism 40 and positioning mechanism 41 are substantially identical, only positioning mechanism 40 will be described in detail. Positioning mechanism 40 facilitates two distinct motions by platen assembly 30 between an uppermost or non-cooking position (see FIG. 3) to a cooking position. In FIGS. 1-3, platen assembly 30 is in the non-cooking position and platen assembly 31 is in the cooking position. In this embodiment, positioning mechanism 40 includes a linear actuator 42 that is linked to two vertical reciprocating shafts 44 by an actuator cross bar linkage 46. Actuator cross bar linkage 46 is clamped to vertical reciprocating shafts 44, which run through linear motion bearings 48. Vertical reciprocating shafts 44 are affixed to arm pivot/stop heads 50. A cantilever beam 52 runs through arm pivot/stop heads 50 through rotational pivot bearings 54. When platen assembly 30 is in its uppermost rotational position, linear actuator 42 is extended to its maximum position, vertical reciprocating shafts 44 and arm pivot/stop heads 50 are extended upward and to a position which forces the back end of cantilever beam 52 to contact rotational bearings 54. In this position, platen assembly 30 is at a predetermined angle in a range of about 45 degrees to about 60 degrees from the horizontal.

Positioning mechanism 40 further comprises a drive motor 56 and position sensor switches 58 (FIG. 3). Drive motor 56 is interconnected with motor controller 64. A pulse encoder 66 is associated with motor 56 and provides a pulse train to controller 62 when motor 56 is being driven. Position switches 58 are mounted on reciprocating shafts 44 to provide position information to controller 62. In alternate embodiments, position switches 58 may be eliminated.

Prior to a cook cycle, platen assembly 30 is in its non-cooking position. In response to user activation of activation buttons 60, controller 62 initiates a cook cycle by controlling motor controller 64 to drive motor 56 to cause positioning mechanism 40 to move platen assembly 30 from the non-cooking position to a cooking position. For example, platen assembly 31 is shown in the cooking position.

Positioning mechanism 40 causes platen assembly 30 to descend both vertically and through an arc caused by the cantilever weight of platen assembly 30 maintaining contact between rotational bearings 54 and the back of cantilever beam 52. When cantilever beam 52 and platen assembly 30 become parallel with lower platen 24, the stop portion of arm pivot/stop head 50 stops the rotational motion of cantilever beam 52 causing purely vertical motion of platen assembly 30 from this point and further down toward surface 26 of lower platen 24. When upper platen 32 makes contact with a food product 72, controller 62 responds by evaluating the upper platen's initial product gap, comparing the gap with the cooking recipe, verifying that the gap is within the recipe parameters, then bringing upper platen 32 to an initial cooking position and initiating a cook procedure. During the cook procedure upper platen 32 may be moved based on the requirements of the cooking recipe. For example, upper platen 32 may be moved due to changed food product thickness (loss of grease or water) or for applying more or less pressure to the food product at different times during the cook procedure.

When the cook procedure is completed, controller 62 controls motor controller 64 to drive linear actuator 42 to move platen assembly 30 vertically upward from the cooking position to the non-cooking position. The cantilever weight of upper platen 32 maintains contact between arm pivot/stop head 50 until the back of cantilever beam 52 makes contact with rotational pivot bearing 54. This movement ensures that platen assembly 30 is constantly parallel to lower platen 24 during this stage of upper platen travel. Once cantilever beam 52 makes contact with rotational pivot bearing 54 the vertical motion is changed to rotational motion to a point where platen assembly 30 is rotated through the predetermined angle to the non-cooking position. Controller 60 causes an audible signal to be sounded (e.g., about two seconds) prior to the start of upward movement of platen assembly 30 to alert the operator of impending upper platen movement.

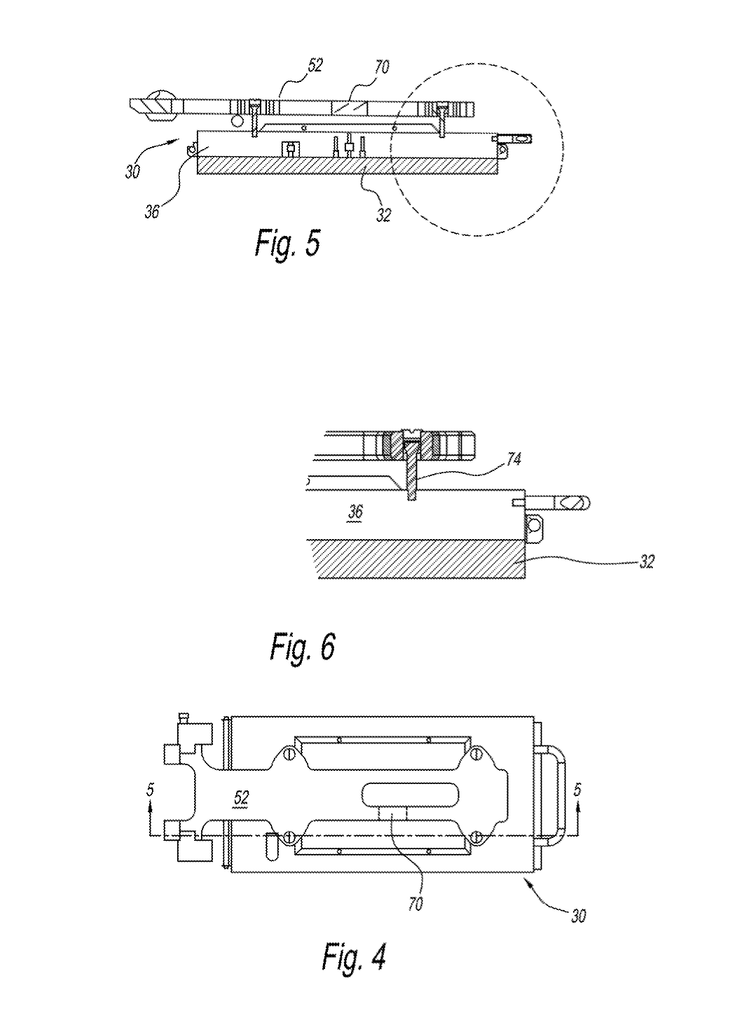

Referring to FIGS. 4-6, a detector 70 provides a trigger signal as upper platen 32 makes contact with food product 72. Controller 62 responds to the trigger signal to control motor controller 64 to cause positioning mechanism 40 to evaluate the upper platen's initial product gap, comparing the gap with the recipe, verifying that the gap is within the cooking recipe parameters, then bring upper platen 32 to the initial cooking position. At this time, controller 62 begins the cooking procedure. Detector 70 comprises a front distance sensor 80 and a rear distance sensor 82 disposed in or on cantilever beam 52.

When upper platen 32 stops moving because it makes contact with a food product, its motion comes to a stop or continues to move based on the cooking parameters inputted into controller 62. Positioning mechanism 40 continues to move cantilever beam 52 vertically downward toward casing 36. Detector 70 senses a small change in the distance between cantilever beam 52 and casing 36 to provide the signal that triggers positioning mechanism 40 to bring upper platen 32 to the initial cooking position. Other types of detectors may be used, some of which are shown in U.S. Pat. No. 8,109,207.

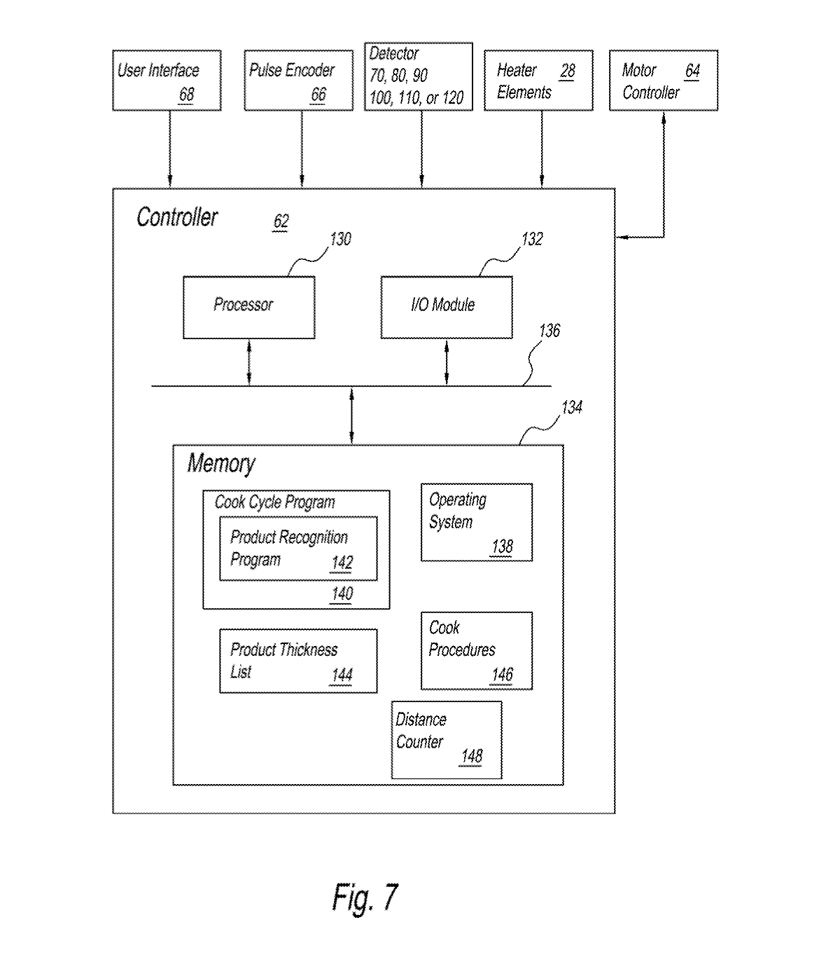

Referring to FIG. 7, controller 62 includes a processor 130 interconnected by a bus 136 with an input/output (I/O) module 132 and a memory 134. Memory 134 may be any suitable memory that includes, random access memory (RAM), read only memory (ROM), flash or other memory types or any combination thereof. Processor 130 may be any suitable processor that is capable of running programs that execute cook cycles including cook procedures. I/O module 132 contains interfaces to each of a plurality of input/output devices, including user interface 68, pulse encoder 66, detector 70, heater elements 28, motor controller 64, temperature sensors 90 and any other input/output devices included in a clamshell grill.

Memory 134 stores a plurality of programs and parameter data including a product menu selection program 140, an operating system 142, a time compensation program 300, a platen movement procedures program 141, a distance counter 148, and a product thickness library 150. Product thickness library 150 includes a set of recipes, each with a range of product thicknesses, for a set of food products and matching cooking procedures or recipes for use by clamshell grill 20. For example, product thickness library 150 includes a cooking recipe for bacon, a cooking recipe for a hamburger, a cooking recipe for a chicken patty and so on.

A cooking recipe, for example, may simply be a cook time or may also include temperatures for different portions of the cook time, different pressures and/or gap distances for upper platen 32 at different portions of the cook time.

Product menu selection program 140 includes a product selection correction program 200 that recognizes a food product 72 currently on the grill surface 26 of lower platen 24 of FIGS. 1-6 and that corrects for erroneous selections made by an operator in a manual mode. The recognition is based on a travel distance of upper platen 32 measured between a reference point to a position at which it makes contact with food product 72. When clamshell grill 20 is first started from a cold start, a preheat mode is used before food product 72 can be placed on lower platen 24. In the preheat mode, platen assembly 30 is lowered until it comes to a stop on lower platen 24. The heaters for lower platen 24 and upper platen 32 are turned on and the platen surfaces are heated to their preset temperatures.

After upper platen 32 has been preheated, platen assembly 30 is raised to its upper most non-cooking position to allow the operator to safely place food product 72 on lower platen 24. As platen assembly 30 begins to rise, cantilever beam 52 reaches the end of the float distance, detector 70 generates a signal that controller 62 uses as the reference point. This reference point represents a reference count value, e.g., zero, of surface 26 of lower platen 24.

As platen assembly 30 continues to rise, encoder pulses are counted from the reference point to the non-cooking position. Controller 62 records the total count value from the reference point to the upper most non-cooking position, which represents a predetermined reference count value. After food product 72 is placed on lower platen 24, platen assembly 30 is again lowered. When upper platen 32 contacts food product 72, detector 70 emits a signal, which triggers controller 62 to record the encoder pulse count value at the time of contact with food product 72. The product thickness is represented by the difference between the pulse count value at the food product contact time and the predetermined reference count value. The pulse count at contact time with upper platen 32 represents a distance of a gap between upper platen 32 and lower platen 24 and as well as thickness of food product 72.

It will be apparent to those skilled in the art that other techniques of measuring the travel distance can be used. For example, the travel distance can be measured by the time that elapses between current triggered count value and the reference point value. The elapsed time, for example, is measured by counting pulses from a timing source, such as a clock. This elapsed time or pulse count is recorded in distance counter 148. Product selection correction program 200 uses distance to recognize a product thickness and uses the recognized product thickness to select a product cook menu from product thickness library 150 that matches the product thickness.

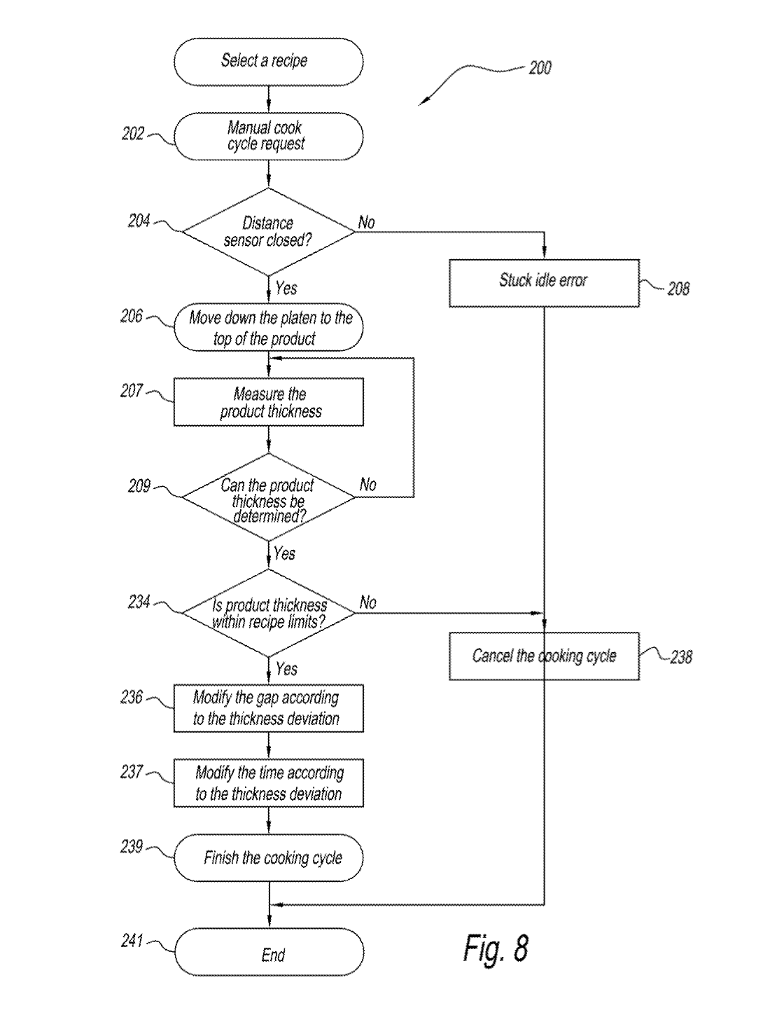

Referring to FIG. 8, processor 130 executes a process 200 by receiving a manual cycle request 202 and determining if a distance sensor is closed 204. If distance sensor is closed, then the system sets a stuck idle error 208 and the cook cycle is cancelled 238. If the distance sensor is not closed, then processor 130 issues a command to move down to the top of the product 206 indicated by the distance sensor 212. The processor then measures the product thickness 207 and seeks to determine if the product thickness can be measured 209. If the product thickness cannot be determined, then it returns to step 207. If the product thickness can be determined, then the processor compares the actual product thickness to the product thickness range or limits set for a particular recipe 234. If the actual product thickness is not within the product thickness limits set forth in the recipe, then the program cancels the cooking cycle 238. If actual product thickness is within the recipe limits, then the program modifies the gap 236 and/or cooking time 237 according to the thickness deviation. If within the recipe limits, then the control monitors the distance sensor to evaluate product conditions and executes the recipe program to completion. If the product is not at the median of the product thickness limits, then the recipe modifies the gap, and/or time, and/or temperature to compensate for non-nominal product thickness. As an example, the gap height changes proportional to the product deviation and/or the time is modified to the square of the thickness deviation. Thereafter, the cooking cycle is finished 239 and the program ends 241.

In FIG. 2 there are one or more temperature sensors 90, one for the front cook zone, one for the middle cook zone and one for the rear cook zone. One or more additional temperature sensors (not shown) may be disposed in the upper platen. Thus, multiple sets of data are considered to make a time compensation decision together with the point in time of the cook cycle or cook time of the food product as well. “Time Compensation” involves an adjustment of cook time to improve product quality and safety, especially for “less than full loads”.

The present disclosure having been thus described with particular reference to the preferred forms thereof, it will be obvious that various changes and modifications may be made therein without departing from the spirit and scope of the present disclosure as defined in the appended claims.

What is claimed is:

1. A clamshell grill comprising:
at least one upper platen and a lower platen;
a positioning mechanism;
a controller comprising a processor, a memory, and at least one program:
at least one initial cooking recipe stored in said memory, each said initial cooking recipe comprising at least one cooking parameter selected from the group consisting of: a cooking time, cooking temperature and a cooking gap between said upper and lower platens; and
a user interface that allows a user to select said initial cooking recipe for a food product disposed on said lower platen;
wherein said processor executes said program to perform operations comprising:
selecting said initial cooking recipe, operating said positioning mechanism to move said upper platen toward said lower platen until an actual product thickness is determined; and
determining if said actual product thickness of said food product is greater than or less than a cooking recipe's product thickness; and
if the actual product thickness of said food product is greater than or less than said cooking recipe's product thickness, then executing a modified cooking recipe to accommodate a change in said actual product thickness during a cooking cycle, wherein said modified cooking recipe adjusts at least one said parameter of said initial cooking recipe.

2. The clamshell grill according to claim 1, wherein each said parameter of said initial recipe includes an upper and lower limit, if said cooking gap is within said upper or lower limits, then a cooking operation for cooking said food product is executed by adjusting said cooking temperature and/or said cooking time and/or cooking gap.

3. The clamshell grill of claim 2, wherein said operations further comprise:
cancelling said initial cooking recipe selection if said thickness is outside the upper or lower limit of said cooking gap as identified within said initial cooking recipe on said lower platen.

4. The clamshell grill of claim 1, wherein said program continues to determine if said thickness of said food product is greater than or less than said cooking gap in said initial cooking recipe, then modifying said cooking gap according to an algorithm with the recipe to accommodate a change in said actual product thickness of said food product until cessation of a cooking operation.

5. A clamshell grill comprising:
an upper platen and a lower platen;
a plurality of cooking zones disposed on said upper platen and said lower platen, wherein;
each of said cooking zone comprising a temperature sensor and a heater;
each of said upper platens comprising at least one distance sensor; and
a controller comprising a processor and a gap compensation program, wherein said processor executes said gap compensation program to obtain gap values from each of said distance sensors, to calculate a delta of a difference between a set point and said gap value for each of said cooking lane, and to adjust a cook cycle gap based on said plurality of deltas.

6. The clamshell grill of claim 5, wherein said adjustment comprises an expansion or retraction of said cook cycle gap for a product currently being cooked.

7. A method adjusting cooking parameters of a cooking recipe for operation of a clamshell grill comprising: at least one upper platen and a lower platen; a positioning mechanism; a controller comprising a processor, a memory, and at least one program; at least one initial cooking recipe stored in said memory, each said initial cooking recipe comprising at least one cooking parameter selected from the group consisting of: a cooking time, cooking temperature and a cooking gap between said upper and lower platens; and a user interface that allows a user to select said initial cooking recipe for a food product disposed on said lower platen; said method comprising:
selecting said initial cooking recipe;
operating said positioning mechanism to move said upper platen toward said lower platen until said cooking gap associated with said initial cooking recipe is reached;
determining if an actual product thickness of said food product is greater than or less than a cooking recipe's product thickness; and
if the actual product thickness of said food product is greater than or less than said cooking recipe's product thickness, executing a modified cooking recipe to accommodate a change in said actual product thickness during a cooking cycle, wherein said modified cooking recipe adjusts at least one said parameter of said initial cooking recipe.
